(19) United States
(12) Patent Application Publication
(10) Pub. No.: US 2009/0260255 A1
(43) Pub. Date: Oct. 22, 2009

(54) DRYING APPARATUS FOR PLATE ELEMENTS FOR ELECTRONICS AND THE LIKE, AND RELATIVE METHOD

(75) Inventor: Andrea BACCINI, San Biagio di Callalta (TV) (IT)

Correspondence Address: HAMRE, SCHUMANN, MUELLER & LARSON, P.C., P.O. BOX 2902, MINNEAPOLIS, MN, 55402-0902, US

(73) Assignee: APPLIED MATERIALS BACCINI SPA CON SOCIO UNICO, San Biagio di Callalta (TV) (IT)

(21) Appl. No.: 12/257,468

(22) Filed: Oct. 24, 2008

(30) Foreign Application Priority Data
Oct. 24, 2007 (IT) UD2007A000200

(51) Int. Cl. F26B 19/00

(52) U.S. Cl. 34/508; 34/201

(57) ABSTRACT

A drying apparatus for silicon or alumina-based plate elements, such as the type for electronics, or other types of plates for electronics, comprises an oven that develops along a path and having a drying chamber that develops along the path, on a relative lying plane. The oven has an entrance (21) into the chamber and an exit from the chamber. The plate elements are fed into the chamber from the entrance to the exit along the path by means of a translation unit in order to effect a drying cycle. The translation unit comprises planar support elements able to advance along the chamber, which are disposed along the path and orthogonally thereto and inclined downwards with respect to the lying plane of the chamber by a relative angle. The plate elements are disposed on the planar support elements so as to define, during normal use, a passage way for the drying air, also below the plate elements.

### FIELD OF THE INVENTION

The present invention concerns a drying apparatus for silicon or alumina-based plate elements, such as the type for electronics, or other types of plates for electronics, advantageously wafers, in particular, but not only, for photovoltaic cells and/or green tape circuits, and also similar or comparable.

### BACKGROUND OF THE INVENTION

Electronic circuits, single or multi-layered planar plate elements, silicon or aluminum oxide based, in particular, but not only, of the photovoltaic cell type, are known.

The photovoltaic cells are generally 16 cm by 16 cm in size, but can be even smaller, and usually undergo a treatment known as “wet metallization” and a subsequent drying in suitable drying apparatuses of a known kind.

Known drying apparatuses comprise an oven with a substantially rectilinear development which is provided with a drying chamber maintained at a determinate temperature, or with two or more zones in sequence at defined levels and differentiated in temperature, in which each zone has a specific temperature and the relative adjacent zone has a temperature correlated to the desired drying and/or baking cycle.

A conveyor belt, normally with links, but also of other types, on which the electronic circuits are disposed one by one in sequence, enters the oven and advances continuously, keeping the circuit to be dried and/or baked in the oven for the amount of time needed to perform a determinate drying cycle, typically for about 45 minutes.

One disadvantage of these known apparatuses is the considerable energy consumption required for achieving the desired drying of the electronic circuits, due to the heat dispersion towards the outside and to the ineffective use of the heat energy supplied to the drying chamber.

Because of this, the delivery flow rate of the drying air and the auxiliary machines required for the movement of the air in the oven, are usually over-sized, with an obvious waste of energy resources. The relative resulting drying chamber may therefore have extremely bulky sizes, particularly in width and height, while the fact remains that its length depends on the speed of advance and on the type of drying cycle.

Purpose of the present invention is therefore to avoid the disadvantages of the state of the art and to achieve a drying apparatus, and a relative method, for plate elements, in particular for electronics, which allows an optimal use of the heat energy supplied to the drying chamber, maintaining or improving the performance of the drying and/or baking cycle, which leads to a considerable reduction in energy consumption and in operational costs.

The Applicant has devised, tested and embodied the present invention to overcome the shortcomings of the state of the art and to obtain these and other purposes and advantages.

### SUMMARY OF THE INVENTION

The present invention is set forth and characterized in the independent claims, while the dependent claims describe other characteristics of the invention or variants to the main inventive idea.

In accordance with the above purpose, a drying apparatus for silicon or alumina-based plate elements, such as those for electronics, or other types of plates for electronics, comprises an oven which develops according to a determinate path and has a drying chamber that develops along the path, on a relative lying plane. The oven has an entrance into the chamber and an exit from the chamber and the plate elements are able to be fed into the drying chamber from the entrance to the exit along said path by means of a translation unit, so as to perform a drying cycle.

In accordance with a characteristic feature of the present invention, the translation unit comprises planar support elements able to advance along the drying chamber. The planar support elements are disposed along said path and orthogonal to said path, inclined downwards by a relative angle with respect to the lying plane of the drying chamber. The plate elements are able to be disposed on the planar support elements so as to define, in normal conditions of use, a passage way for the drying air also underneath the plate elements, as well as above them.

Advantageously, the path of the oven is substantially rectilinear, along a longitudinal axis.

Alternatively, the oven could develop along a curved, circular, elliptical or other path, open or closed, according to needs.

An advantageous solution provides to make the planar support elements as two conveyor belts adjacent and parallel in a closed ring, inclined downwards towards the center line of the drying chamber.

The belts can advance continuously, at a predetermined speed according to the drying cycle.

Alternatively, the belts can advance by predetermined steps, determining temporary stops in predetermined zones of the oven maintained at a desired temperature, according to the desired baking cycle.

Advantageously, the drying oven and the translation unit are controlled and commanded by an electronic control unit, according to pre-established or selectively programmable work, drying and/or baking programs and cycles.

An advantageous variant of the present invention provides to feed the drying air in counter-flow with respect to the advance of the plate elements, that is, from the exit to the entrance of the drying chamber.

Another variant provides to pre-heat the drying air that is introduced into the drying chamber.

Another variant provides that the used air is suctioned downwards with respect to the drying chamber, by means of a suction device connected to the chamber by means of pipes that direct the air downwards.

The connection socket of the pipes with the drying chamber is lateral or underneath with respect to the planar support elements so that, in normal conditions of use, advantageously, condensation or other contaminating elements of the used air are prevented from falling due to gravity directly toward the planar support elements and therefore onto the plate elements. This solution provides the advantageous use of a container to collect the condensation that falls due to gravity, downstream of the suction device.

An advantageous solution of the invention provides to re-circulate the used air so as to use it again in the pre-heating before it is introduced into the drying chamber.

A method according to the present invention provides, in a drying step, to use an oven that develops along a determined path and has a drying chamber that develops along said path, on a relative lying plane, in which the oven has an entrance into the chamber and an exit from the chamber, the plate elements being fed into the chamber from the entrance to the exit along the path by means of a translation unit in order to perform a drying cycle.

In accordance with a characteristic feature of the present invention, the translation unit provides to use planar support elements that transport along the chamber the planar support elements that are disposed inclined downwards with respect to the axis of the path and with respect to the lying plane so that the drying air transits both above and below the plate elements.

The present invention allows an optimal use of the heat energy supplied to the drying chamber, maintaining or improving the performance of the drying and/or baking cycle, which leads to a considerable reduction in energy and operating costs.

In particular, the air channel that forms between the inclined planar support elements and the plate elements allows a uniform and homogeneous drying of the latter on both their faces, as the drying air flows past them both simultaneously. This leads to a more efficient use of the heat energy of the drying air and an optimal definition of the rate of flow of the drying air, which is considerably lower than in the state of the art.

The counter-flow introduction of the drying air, as well as the pre-heating and possible re-circulating thereof, promote even more the optimization of the performance of the drying cycle.

This also allows the correct sizing of the auxiliary units used for pre-heating, introducing and picking up the drying air, such as ventilators, aspirators, heat exchangers, and pipes in general.

Thanks to the solutions described, it is possible to considerably contain the sizes of the drying oven, which as a result is more compact, particularly in width and height, and the sizes of the drying chamber are comparable to those of the plate elements to be dried.

This also leads to a lower heat dispersion towards the outside, saving energy and resulting in a greater level of comfort for the operators.

An advantageous solution, especially taking into account the compact character of the drying oven, provides that the chamber is defined by lateral walls and by an upper lid which is hinged to one of the lateral walls in order to be selectively mobile so as to define an open condition and a closed condition of the chamber.

A further variant provides that heating means is disposed along the drying oven, within the relative chamber. The heating means is able to heat the oven and the drying air for the desired drying and/or baking cycle.

In an advantageous solution, the heating means can define a determinate heat profile along the path of the drying oven. The heat profile can have a constant temperature. In a variant, the heat profile increases along the path of the oven in the direction of advance of the plate elements. In another variant, on the contrary, the heat profile decreases.

According to another solution, the heat profile inside the drying chamber defines zones with different temperatures, variable or constant, along the path of the oven. For example, there can be alternate zones with higher and lower temperature, or adjacent zones with temperatures increasing or decreasing in steps, or in a continuous manner, possibly alternated with zones at a constant temperature.

Advantageously, the type of heat profile can be selectively determined and managed by a control unit, which activates in a differentiated or uniform manner the heating means along the path of the oven, so as to create any type of temperature development along the oven, coherently with the desired drying and/or baking cycle.

### BRIEF DESCRIPTION OF THE DRAWINGS

These and other characteristics of the present invention will become apparent from the following description of some preferential forms of embodiment, given as a non-restrictive example with reference to the attached drawings wherein:

FIG. 1 is a perspective view of a drying apparatus according to the present invention;

FIG. 2 is a partial cross section of the drying apparatus in FIG. 1;

FIG. 3 in another partial cross section of the drying apparatus in FIG. 1;

FIG. 4 is a partial lateral section of the drying apparatus in FIG. 1.

### DETAILED DESCRIPTION OF A PREFERENTIAL FORM OF EMBODIMENT

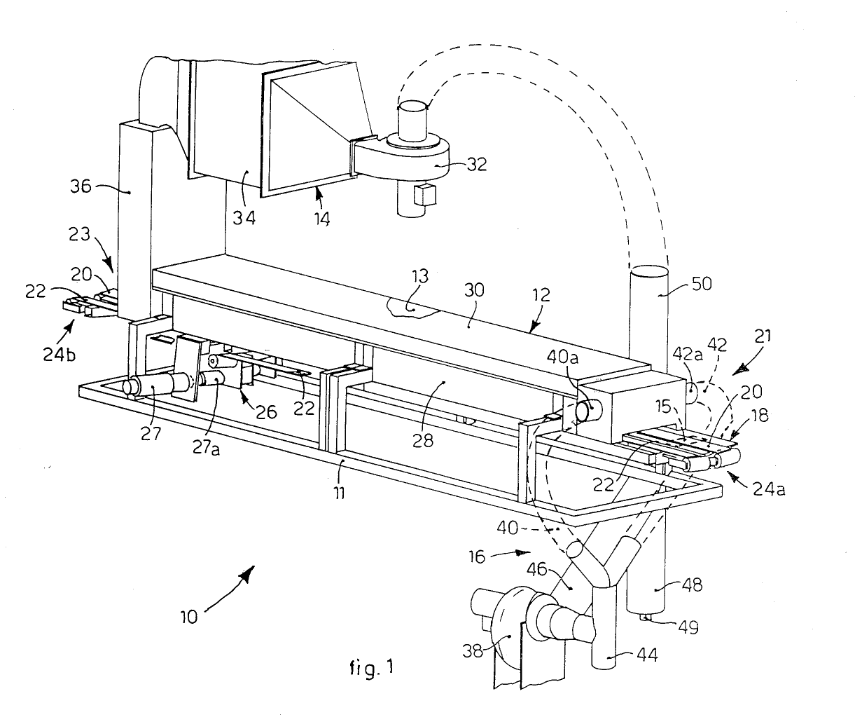

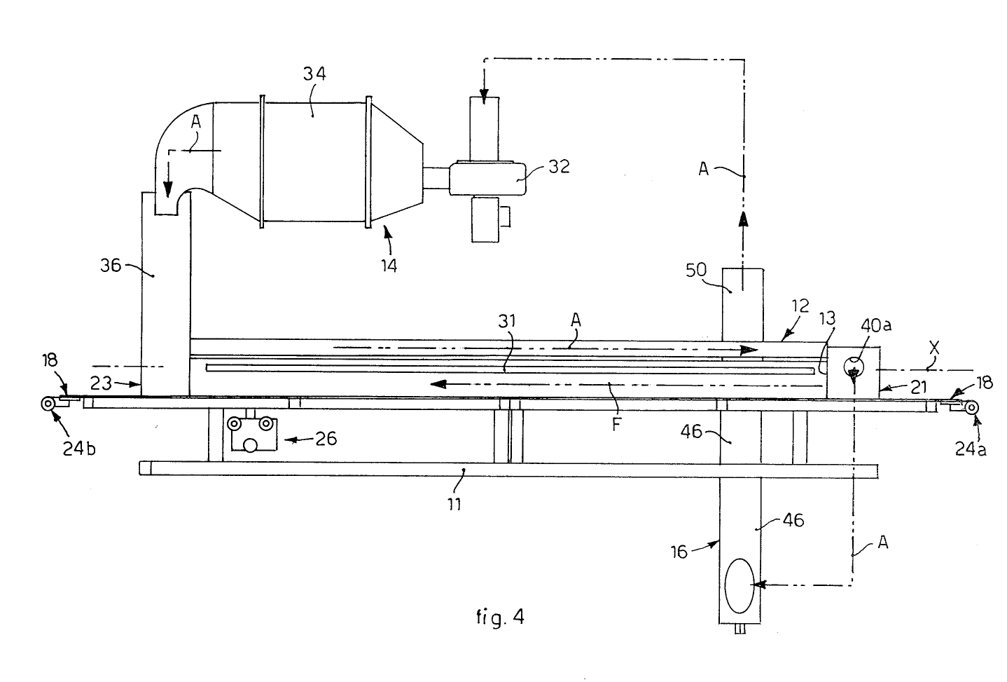

With reference to FIG. 1, a drying apparatus 10 for drying or baking silicon wafers 15 comprises a drying oven 12, substantially linear in development, according to a path, or longitudinal axis X (FIG. 4).

The oven 12 is mounted in a stable manner on a supporting frame 11. The oven 12 comprises lateral walls 28 and an upper lid 30 which can be opened and closed, so as to define a drying chamber 13, developing longitudinally along the X axis. The chamber 13 has an entrance 21 and an exit 23, identified respectively to the right and to the left in FIG. 4, into which the wafers 15 are respectively fed and extracted, in the direction indicated by the arrow F in FIG. 4. In the oven 12, along the chamber 13 and in particular immediately below the lid 30, heating lamps 31 are installed. The lamps 31 supply the necessary heat to the inner environment of the chamber 13 and heat the air that flows into it, in order to dry the wafers 15. The temperature defined by the lamps can be constant along the oven, increasing, decreasing, or it can define zones with different temperatures, with an inverted or alternate temperature development, so as to define in the chamber 13 any desired heat profile along the axis X.

As an alternative to the lamps, heating electric resistances can be used as heating means.

Along the oven 12, inside the chamber 13, a translation unit 18 is provided to translate the wafers 15 along the axis X, in the direction indicated by the arrow F in FIG. 4.

The translation unit 18 comprises two plane belts 20 and 22, with a longitudinal development.

The belts 20 and 22, in the inward path, that is, from the entrance 21 to the exit 23, run in the chamber 12. In the return path, from the exit 23 to the entrance 21, the belts 20 and 22 run below the level of the chamber 13, externally thereto, but in any case always parallel to the axis X (closed ring).

Motion is transmitted to the belts 20 and 22 during entry and exit by a unit of drive rollers 24, having rollers 24a at the entrance and rollers 24b at the exit of the chamber 13, driven by a drive unit 26.

The drive unit 26 has a motor 27, in this case disposed below the oven 12. The shaft of the motor 27 supplies rotation to a drive roller 27a underneath the level of the chamber 13, which, in this constructive case, cooperates with the belt 22. The belt 22, coming from the rollers 24b, is diverted downwards in order to be moved by the drive roller 27a and passes on a guide roller 27b, which takes it back to the necessary level with respect to the chamber 13, to then carry on towards the rollers 24a.

In the same way, driven rollers 27c and 27d move the belt 20.

The belts 20 and 22 are substantially of the same size in length and width and are disposed inclined downwards, by a determinate angle with respect to the axis X, advantageously towards the center line of the chamber 13.

In other words, the lying planes of the belts 20 and 22 form respective acute angles, α and β, with a plane Q parallel to a lying plane P of the oven 12, the latter being defined by the plane on which an improper sheaf of straight lines lies perpendicular to the longitudinal axis X.

In other words again, internal edges 20a and 22a of the belts 20 and 22 are positioned adjacent or in contact, advantageously in correspondence with the axis X, that is, with the centre line of the chamber 13. On the contrary, the external edges 20b and 22b of the belts 20, 22 are rotated upwards, around the axis X, by a determinate acute angle.

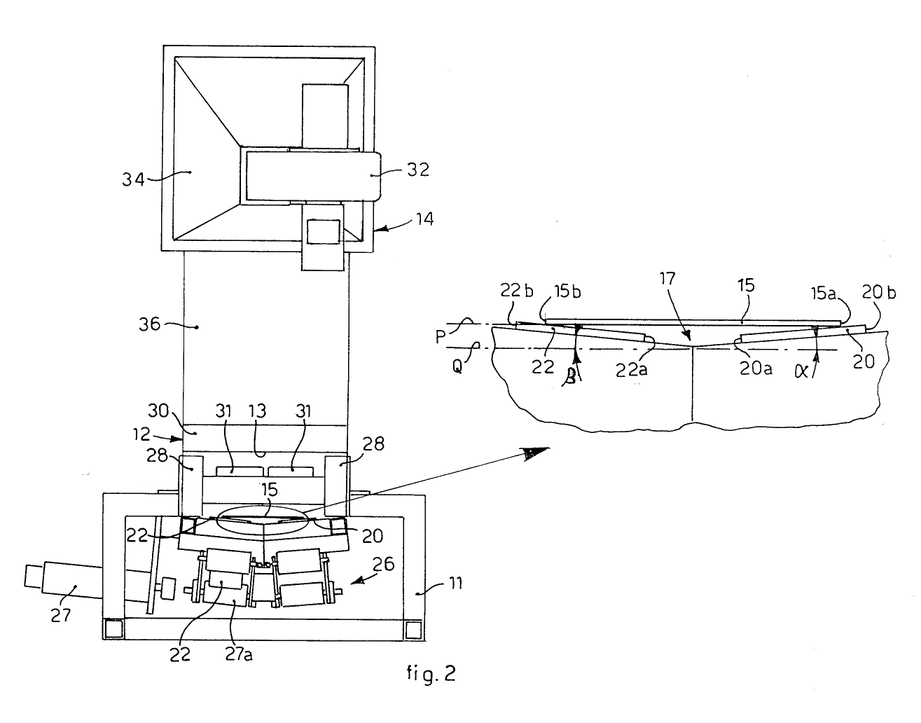

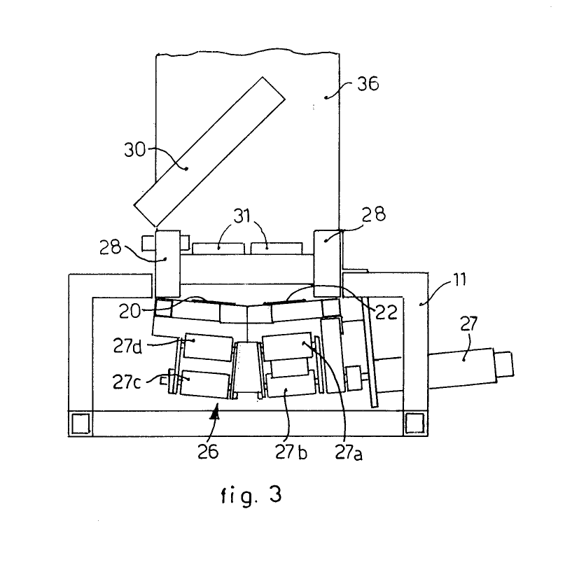

The solution used in FIGS. 2 and 3 provides that the angles α and β have the same amplitude; in practice, this makes it easier to achieve.

The belts 20 and 22 seen frontally, as for example in FIGS. 2 and 3, therefore assume a “V” shaped configuration or geometric disposition.

In a coherent manner, the rollers 24, as well as the drive roller 27a, the guide roller 27b and the driven rollers 27c and 27d, are also inclined like the belts 20 and 22.

The wafers 15 are positioned in sequence on the belts 20 and 22, with one edge 15a resting on the belt 20 on the right and an opposite edge 15b resting on the belt 22 on the left, as can be seen in the enlarged detail in FIG. 2.

In this way an empty space, or air passage way 17, is created below the wafer 15 and above the belts 20 and 22, in which heated air continuously passes. In this way, each wafer 15 is subjected to the passage of a flow of drying air both below and above, promoting a better drying, with a lower consumption of hot air, particularly in terms of rate of flow and heat energy.

The invention provides to introduce a determinate flow rate of air into the chamber 13 in correspondence with the exit 23, by means of a first unit 14, installed substantially above the oven 12, which supplies the air. The used air is removed from the chamber 13 by means of a second removal unit 16 in correspondence with the entrance 21. The introduction of air is necessary for the correct and efficient development of the drying process of the wafers 15.

The first unit 14 consists, in its essential components, of a ventilator 32, to push the air towards the exit 23 and a flow conveyor 36, that conveys the air pushed by the ventilator 32 inside the chamber 13. The second unit 16 provides an aspirator 38, in correspondence with the entrance 21, to suck in the used air, or fumes, from the chamber 13, by means of suction pipes 40 and 42 that converge into a single collector 44 in correspondence with the air intake of the aspirator 38.

The air is heated by the lamps 31, in its path along the chamber 13 and exits as used air, or fumes, in correspondence with the entrance 21. The path of the air is indicated by the arrows A in FIG. 4.

As is clear from the drawings, the path of the air, arrow A, is in counter flow with respect to the feed of the wafers 15, arrow F, with evident advantages in terms of heat exchange and optimization of the use of the enthalpy content of the drying air.

An advantageous solution of the present invention provides to pre-heat the air that enters into the chamber 13, in correspondence with the exit 23.

In order to do this, the apparatus 10 comprises a pre-heating device 34 for the air, such as a heat exchanger, associated with the first unit 14 and installed downstream of the ventilator 32 and upstream of the conveyor 36. In this case all the above is mounted above the chamber 13.

In this way the incoming air, once pre-heated, is already at a considerable temperature which can be compared to that of the heated environment inside the chamber 13, for example comprised between about 90° and about 120°. This determines a better performance of the drying cycle, a lower consumption of energy of the lamps 31 and the optimization of the flow rate of the drying air required to complete the correct and desired drying and/or baking cycle.

These energy advantages allow to size the chamber 13, and therefore the oven 12, to the minimum volume required for an efficient drying, considerably reducing the bulk and the costs of the plant. In particular, as can be seen in FIGS. 1, 2 and 3, the oven 12 is very compact, both in width and in height, and the chamber 13, seen in cross section, has sizes comparable with the sizes of the wafers 15, without taking into consideration the volumes required for mounting the lamps 31 and the translation unit 18. Another advantage is that it is possible to correctly size, without excessive over-sizing, the ventilator 32 and the aspirator 38, as well as the circuits and the pipes that connect them.

A further advantageous form of embodiment of the present invention concerns the removal of the used air from the chamber 13, and in particular the geometry of the suction, no longer from above, as in known drying ovens, but downwards.

In particular, the aspirator 38 is disposed below the oven 12, the pipes 40 and 42 being connected to the chamber 13 and directing downwards the used air sucked in. The pipes 40 and 42, in particular, are connected to the chamber 13 laterally with respect to the belts 20 and 22, by means of relative connection sockets 40a and 42a made on the lateral walls 28. This eliminates possible returns of condensation or contaminants contained in the used air towards the wafers 15 being dried.

This effect is also obtained with a disposition of the pipes 40 and 42 below the belts 20, 22, that is, with the sockets 40a and 42a below the belts 20 and 22.

The used air, sucked downwards, is directed by the aspirator 38 towards a circuit, at this point completely separate from the chamber 13, formed by pipes 46 and 50, which re-circulate the used air to the ventilator 32, for an advantageous recovery of heat. The humidity present in the used air, possibly comprising contaminants that evolve from the wafers 15 during the drying and following the variation in temperature and pressure due to the suction, condenses and falls due to gravity into a container 48 for the collection of condensation. The container 48 is installed between the pipe 46 and the pipe 50, therefore far from and separated from the wafers 15, preventing the contamination thereof. The container 48 can by periodically drained by means of a suitable drain valve 49.

A further advantageous form of embodiment, in particular associated with the limited sizes of the oven 12 that are obtained with the present invention, provides to make the lid 30 of the oven 12 hinged laterally to one of the walls 28 (FIG. 3), making it easy to open and close. In this way it is possible to intervene, inspect, maintain and replace the underlying components of the oven 12, in particular the lamps 31, rapidly and easily.

It is clear that modifications and/or additions of parts and/or steps may be made to the drying apparatus 10 and relative method as described heretofore, without departing from the field and scope of the present invention.

It is also clear that, although the present invention has been described with reference to specific examples, a person of skill in the art shall certainly be able to achieve many other equivalent forms of drying apparatus and relative method, having the characteristics as set forth in the claims and hence all coming within the field of protection defined thereby.

1. A drying apparatus for silicon or alumina-based plate elements, such as the type for electronics, or other types of plates for electronics, comprising an oven that develops along a path (X) and having a drying chamber that develops along said path (X), on a relative laying plane (P), wherein the oven has an entrance into the chamber and an exit from the chamber, the plate elements being able to be fed into the chamber from the entrance to the exit along the path (X) by means of a translation unit in order to effect a drying cycle, wherein the translation unit comprises planar support elements able to advance along the chamber, the planar support elements being disposed along the path (X) of the chamber and orthogonally thereto and inclined downwards with respect to the laying plane (P) by a relative angle (α, β), the plate elements being disposed on said planar support elements so as to define, during normal use, a passage way for the drying air, also below the plate elements.

2. A drying apparatus as in claim 1, wherein said path is a substantially rectilinear longitudinal axis (X).

3. A drying apparatus as in claim 1, wherein the planar support elements extend along the whole path (X).

4. A drying apparatus as in claim 1, wherein the planar support elements are transport belts disposed adjacent along the path (X) of the chamber.

5. A drying apparatus as in claim 1, wherein the angles (α, β) have the same value.

6. A drying apparatus as in claim 1, wherein the angles (α, β) are acute.

7. A drying apparatus as in claim 1, wherein the planar support elements are inclined towards the centerline of the chamber.

8. A drying apparatus as in claim 1, wherein the planar support elements have internal edges which are disposed adjacent in correspondence with the longitudinal axis (X), so that the planar support elements are convergent downwards.

9. A drying apparatus as in claim 1, wherein the planar support elements have external edges rotated, around the longitudinal axis (X), upwards with respect to the internal edges.

10. A drying apparatus as in claim 1, comprising a movement unit to move the translation unit and a drive unit to drive the movement unit.

11. A drying apparatus as in claim 10, wherein the movement unit provides entrance rollers and exit rollers which cooperate with the planar support elements, the axis of rotation of which has an inclination coherent with the inclination of the planar support elements.

12. A drying apparatus as in claim 10, wherein the drive unit is provided with a motor and at least a drive roller operationally connected to the motor and which cooperates with at least one of the planar support elements in order to move said at least one of the planar support elements.

13. A drying apparatus as in claim 12, wherein the drive roller has an inclination coherent with the inclination of at least one of the planar support elements.

14. A drying apparatus as in claim 1, comprising a first unit able to send drying air inside the chamber and a second unit able to pick up the air from the chamber.

15. A drying apparatus as in claim 14, wherein the first unit is able to send the drying air in correspondence with the exit and the second unit is able to pick up the used air in correspondence with the entrance, in order to determine a counter-flow of the drying air with respect to the advance of the plate elements in the chamber.

16. A drying apparatus as in claim 14, comprising pre-heating means able to pre-heat the drying air to a temperature coherent with the desired drying cycle, before the air is introduced into the chamber.

17. A drying apparatus as in claim 14, wherein the second unit comprises a suction device which is disposed under the oven and is connected to the chamber by means of pipes able to direct the used air downwards towards the suction device, the intake of each of the pipes being disposed laterally or below with respect to the planar support elements, so as to prevent, during normal use, the fall of condensation or other contaminants of the used air directly towards the planar support elements and therefore onto the plate elements.

18. A drying apparatus as in claim 17, comprising a container disposed vertically downstream of the suction device in order to collect the condensation or other contaminants of the used air.

19. A drying apparatus as in claim 18, comprising a first pipe, downstream of the suction device, to the end of which the container is connected.

20. A drying apparatus as in claim 19, comprising a second pipe connected to the end of the first pipe and by means of which the used air is re-circled to the first unit.

21. A drying apparatus as in claim 1, wherein the chamber is defined by lateral walls and an upper lid which is hinged to one of the lateral walls so as to be selectively mobile in order to define an open condition and a closed condition of the chamber.

22. A drying apparatus as in claim 1, wherein the oven comprises heating means able to heat the plate elements in order to effect a determinate drying and/or baking cycle.

23. A drying apparatus as in claim 22, wherein the heating means is disposed in the chamber at least above the planar support elements, along the path (X).

24. A drying apparatus as in claim 22, wherein the heating means is able to define a determinate temperature profile along the path (X) of the oven.

25. A drying apparatus as in claim 24, wherein the temperature profile is constant along the path (X).

26. A drying apparatus as in claim 24, wherein the temperature profile is variable along the path (X) according to a pre-defined program coherent with the desired drying and/or baking cycle.

27. A drying apparatus as in claim 24, wherein the temperature profile increases along the path (X).

28. A drying apparatus as in claim 24, wherein the temperature profile decreases along the path (X).

29. A drying apparatus as in claim 24, wherein the temperature profile is able to define different heating zones in the chamber along the path (X), each of which has its own temperature and/or temperature profile, constant or variable.

30. A drying method for silicon or alumina-based plate elements, such as the type for electronics, or other types of plates for electronics, which provides, in a drying step, to use an oven that develops along a path (X) and having a drying chamber that develops along said path (X), on a relative plane (P), wherein the oven has an entrance into the chamber and an exit from the chamber, the plate elements being fed into the chamber from the entrance to the exit along the path (X) by means of a translation unit in order to effect a drying cycle, wherein the translation unit provides to use planar support elements which transport along the chamber the planar support elements, which are thus inclined downwards with respect to the plane (P) so that the drying air transits both above and below the plate elements.

31. A drying method as in claim 30, wherein the drying air introduced into the chamber transits in counter-flow in the chamber with respect to the direction of advance of the plate elements.

32. A drying method as in claim 30, wherein the drying air is subjected to pre-heating before being introduced into the chamber.

33. A drying method as in claim 30, wherein the used air is picked up from the chamber by means of suction downwards by a suction device connected to the entrance of the chamber by means of pipes able to direct the used air downwards towards the suction device, the intake of each of the pipes being disposed laterally or below with respect to the planar support elements, so as to prevent, during normal use, the fall of condensation or other contaminants of the used air directly towards the planar support elements and therefore onto the plate elements.
